(19) United States
(12) Patent Application Publication
(10) Pub. No.: US 2010/0161495 A1
(43) Pub. Date: Jun. 24, 2010

(54) System and method for managing construction project bids and/or unit pricing data

(75) Inventors: Phillip J. Olson, Chicago, IL (US); Mark Olson, Chicago, IL (US)

Correspondence Address: PATENTS+TMS, P.C., 2849 W. ARMITAGE AVE., CHICAGO, IL, 60647, US

(73) Assignee: Shortlister, LLC

(21) Appl. No.: 12/317,004

(22) Filed: Dec. 18, 2008

(51) Int. Cl. G06Q 10/00; G06Q 90/00

(52) U.S. Cl. 705/80; 705/10; 705/400

(57) ABSTRACT

A system and a method manage construction project bids and/or unit pricing data. An online system manages bids for components of a construction project and allows a user to search aggregated unit pricing data. The user may be a bidder or a solicitor and may search construction cost information to obtain product and job-specific pricing. The user may select a construction division and/or a product to research, and the system provides up-to-date cost information. The system conducts a search that may be customized by a location, a construction category and/or a jobsite type. The user may input a user name and a password to access a personal organization tool that manages aspects of a project and provides current information on an active project.

### BACKGROUND OF THE INVENTION

The present invention generally relates to a system and a method for managing construction project bids and/or unit pricing data. More specifically, the present invention relates to an online system that manages bids for components of a construction project and allows a registered user to search aggregated unit pricing data. The registered user may be a bidder or a solicitor and may search construction cost information to obtain product and job-specific pricing. The registered user may select a construction division and/or a product to research, and the system provides real-time cost information. The system conducts a search that may be customized by a location, a construction category and/or a jobsite type. The registered user may input a user name and a password to access a personal organization tool that manages aspects of a construction project and provides current information for an active project.

Typically, in the construction industry, an estimate of a total cost of a construction project is determined by a solicitor of bids before initiation of the construction project. The bids are usually for individual components of the construction project, such as services, materials and other items required for the construction project. The solicitor may be, for example, a general contractor, a developer, an architect, a building owner, an engineer, a facility manager or a homeowner. The bids are used to determine the total cost of the project. The solicitor obtains a lowest possible bid for the highest quality materials and labor. A bidder, such as, for example, a sub-contractor, a specialist, a supplier or a vendor, provides a bid low enough to be accepted by the contractor while obtaining a highest possible profit margin.

Determination of an amount to bid may be difficult and time-consuming for the bidder. For the bidder, accurate estimation of the amount to bid determines if the bid is accepted by the solicitor, if the bidder obtains a profit and the amount of any profit. If the amount of the bid is too high, the solicitor may not accept the bid. If the amount of the bid is too low, the bidder may not obtain a profit, or the amount of the profit may be minimal.

Determination of which bid to accept may be difficult and time-consuming for the solicitor. The profit of the solicitor depends on the total amount of the accepted bids. If the solicitor is a general contractor, the solicitor may be using the accepted bids to present a project bid to an owner or developer. The project bid is based on the accepted bids of the sub-contractors, suppliers and vendors; therefore, the contractor desires a lowest possible bid from each of the sub-contractors, suppliers and vendors. However, the solicitor must also consider the quality of the goods and/or the services associated with the bid.

Moreover, monitoring progress of the construction process and completion of each of the steps of the construction project may also be difficult and time-consuming. If information for the project is not obtained and organized efficiently, steps of the construction, such as initiation of the project or completion of the project, may be delayed; the total cost may exceed the estimate; and/or one or more of the steps of the construction project may be skipped or may have to be completed out of sequence. For example, the general contractor who manages the construction project must typically schedule the services of the different subcontractors to perform their associated step of the construction project in a correct sequence. Typically, the general contractor must also process invoices for payment of the sub-contractors, the suppliers and the vendors.

A need, therefore, exists for a system and a method for managing construction project bids and/or unit pricing data. Further, a need exists for a system and a method for managing construction project bids and/or unit pricing data that enable a solicitor to post a project based on a selected construction category. Still further, a need exists for a system and a method for managing construction project bids and/or unit pricing data that enable a bidder to find and bid on the project. Moreover, a need exits for a system and a method for managing construction project bids and/or unit pricing data that present the bidder with a product pricing survey of specific materials and/or products.

In addition, a need exists for a system and a method for managing construction project bids and/or unit pricing data that aggregate the responses to the product pricing surveys, provide aggregated unit pricing data and enable parameter-based searching of the aggregated unit pricing data. Further, a need exists for a system and a method for managing construction project bids and/or unit pricing data that enable solicitors that receive bids to rank the corresponding bidders. Still further, a need exists for a system and a method for managing construction project bids and/or unit pricing data that utilize the aggregated data to display real-time and/or projected construction activity for geographic regions. Moreover, a need exists for a system and a method for managing construction project bids and/or unit pricing data that automatically notify the bidders of projects that meet user-selected criteria via text message, email and/or an account manager.

### SUMMARY OF THE INVENTION

The present invention generally relates to a system and a method for managing construction project bids and/or unit pricing data. More specifically, the present invention relates to an online system that manages bids for components of a construction project and allows a registered user to search aggregated unit pricing data. The registered user may be a bidder or a solicitor and may search construction cost information to obtain product and job-specific pricing. The bidder may search posted construction projects for projects that match one or more user-selected parameters, such as, for example, a trade category required for the project, a location, a jobsite type and/or the like. The registered user may select a construction division and/or a product to research, and the system provides real-time cost information. The registered user may input a user name and a password to access a personal organization tool that manages aspects of a construction project and provides current information for an active project.

The solicitor may post a project to solicit bids by inputting a location of the project; a building type, such as, for example, commercial, industrial, institutional, residential multi-family, residential single family and/or retail; a construction type, such as, for example, new or renovation; a solicitor type, such as, for example, architect, building owner, engineer, facility manager, general contractor or homeowner; an estimated project value; the trade categories invited to bid on the project; a bid deadline; and/or a worker type, such as, for example, union, non-union or either. The project may be posted on the online bidding tool so that a bidder may input a bid on the project.

The bidder may search for projects on which to bid by inputting a parameter, such as, for example, a location; a bid deadline; an estimated project value; a building type; and/or a trade specialty, such as, for example, general contractor, site construction, concrete, masonry, metals, wood and plastics, thermal and moisture protection, door and windows, finishes, equipment, furnishings, special construction, conveying system, electrical, mechanical and/or handyman. The bidder may input a bid that is forwarded to a solicitor.

Any user may also search construction cost information to obtain product and job-specific pricing. The user may select the construction division and product they are researching, and the online bidding tool provides up-to-date cost information. The search may be customized by location, construction category and/or jobsite type. A registered user may input a user name and password to access a personal organization tool that manages aspects of a project and provides current information on an active project.

To this end, in an embodiment of the present invention, a method for managing construction project bids for a plurality of construction projects for a first user, a second user, a third user and a fourth user wherein the first user, the second user, the third user and the fourth user are different users is provided. The method has the steps of: providing an application via a computer network wherein the computer network is connected to a database and further wherein the application communicates with the database via the computer network wherein the database stores project information associated with each of the plurality of construction projects and further wherein the application is accessed by a terminal connected to the computer network wherein the terminal is located remotely relative to the database wherein the first user posts a first construction project of the plurality of construction projects in the database and further wherein the database is provided by the second user; inputting a bid for the first construction project wherein the third user inputs the bid using the application; transmitting the bid to the first user; presenting the third user with a survey that requests unit pricing information associated with the bid wherein the unit pricing information corresponds to costs associated with the bid and further wherein the application presents the survey; inputting the unit pricing information wherein the third user inputs the unit pricing information using the application; storing the unit pricing information in the database; inputting a parameter using the application; comparing the unit pricing information to the parameter; and displaying the unit pricing information that corresponds to the parameter wherein the application displays the unit pricing information that corresponds to the parameter.

In an embodiment, the method has the step of inputting search criteria that is compared to the project information wherein the application displays a matching construction project from the plurality of construction projects based on comparison of the search criteria to the project information.

In an embodiment, the method has the step of transmitting a message to the third user that indicates acceptance of the bid by the first user.

In an embodiment, the method has the step of generating a ranking for the third user wherein the ranking is based on feedback information input by the first user.

In an embodiment, the method has the step of transmitting the unit pricing information to building modeling software that uses the unit pricing information to calculate a cost estimate for a structure associated with the first construction project.

In an embodiment, the method has the step of displaying the project information for the first construction project and the project information for a second construction project of the plurality of projects.

In an embodiment, the method has the step of sending an update message to the first user that indicates a status of work associated with the first user wherein the update message is based on input by the first user and further wherein the status of the work indicates completion of the work.

In an embodiment, the method has the step of transmitting a discount offer to the first user wherein the discount offer provides a reduced cost for a purchase related to the construction project wherein the second user receives compensation if the first user uses the discount offer for the purchase.

In an embodiment, the method has the step of transmitting a message to the third user that indicates availability of a newly posted construction project from the database wherein the newly posted construction project was not available when the third user input the bid.

In an embodiment, the method has the step of indicating a number of the plurality of construction projects that are located in a first geographic area and a number of the plurality of construction projects that are located in a second geographic area wherein the first geographic area and the second geographic area are different geographic areas.

In an embodiment, the method has the step of obtaining contact information for users of the application wherein the application generates informational cards for the users of the application using the contact information and further wherein the application displays the informational cards.

In an embodiment, the method has the step of inputting a trade category that indicates a type of work provided by the third user wherein the survey is based on the trade category.

In another embodiment of the present invention, a method for managing construction project bids for a first user and a second user that are different users is provided. The method has the steps of: providing an application via a computer network wherein the computer network is connected to a database that communicates with the application via the network and further wherein the application is accessed by a terminal located remotely relative to the database via the computer network; accepting user input for construction projects wherein the user input provides project information associated with the construction projects wherein the application accepts the user input and further wherein the database stores the project information wherein the project information indicates a plurality of types of work required for a corresponding construction project of the construction projects; receiving a parameter that indicates a type of work performed by the first user wherein the application receives the parameter from the first user; displaying a matching project from the construction projects wherein the matching project is selected based on comparison of the plurality of types of work required to the type of work provided by the first user and further wherein the application displays the matching project; receiving a bid from the first user wherein the application receives the bid; and obtaining unit pricing data associated with the bid wherein the unit pricing information corresponds to expenses associated with the bid and further wherein the unit pricing data is stored by the database wherein the unit pricing data corresponds to the type of work provided by the user.

In an embodiment, the method has the step of presenting a survey that obtains the unit pricing data wherein the application selects the survey based on the type of work provided by the first user.

In an embodiment, the method has the step of displaying the unit pricing data that is associated with a geographic area selected by the second user.

In an embodiment, the method has the step of transmitting a message to the first user wherein the message indicates that one or more of the plurality of types of work required for a new construction project corresponds to the type of work provided by the first user.

In an embodiment, the method has the step of displaying an account management webpage to the second user wherein the account management webpage indicates that the bid was transmitted.

In another embodiment of the present invention, a system for managing construction project bids is provided. The system has a database connected to a network wherein the database stores project information associated with a plurality of construction projects; an aplication associated with the database wherein the application is accessed by a computer connected to the network and further wherein the application accepts a bid for a first construction project of the plurality of construction projects; and a survey presented by the application wherein the survey obtains unit pricing data that corresponds to costs associated with the bid and further wherein the database stores the unit pricing data wherein the application accepts a parameter and further wherein the application displays the unit pricing data that corresponds to the parameter.

In an embodiment, the system has an account manager provided by the application wherein the account manager indicates entry of the bid.

In an embodiment, the system has user input that indicates a type of work provided in association with the bid wherein the application accepts the user input and further wherein the survey is selected based on the type of work provided in association with the bid.

It is, therefore, an advantage of the present invention to provide a system and a method for managing construction project bids and/or unit pricing data.

Another advantage of the present invention is to provide a system and a method for managing construction project bids and/or unit pricing data that enable a solicitor to post a project based on a selected construction category.

Yet another advantage of the present invention is to provide a system and a method for managing construction project bids and/or unit pricing data that enable a bidder to find and bid on the project.

And, another advantage of the present invention is to provide a system and a method for managing construction project bids and/or unit pricing data that present the bidder with a product pricing survey of specific materials and/or products.

Further, an advantage of the present invention is to provide a system and a method for managing construction project bids and/or unit pricing data that aggregate the responses to the product pricing surveys, provide aggregated data and enable parameter-based searching of the aggregated data.

Yet another advantage of the present invention is to provide a system and a method for managing construction project bids and/or unit pricing data that enable solicitors that receive bids to rank the corresponding bidders.

A still further advantage of the present invention is to provide a system and a method for managing construction project bids and/or unit pricing data that format the aggregated data for input into building information modeling software.

Further, an advantage of the present invention is to provide a system and a method for managing construction project bids and/or unit pricing data that utilize the aggregated data to display real-time and/or projected construction activity for geographic regions.

Yet another advantage of the present invention is to provide a system and a method for managing construction project bids and/or unit pricing data that automatically notify the bidders of projects that meet user-selected criteria via text message, email and/or an account manager.

Moreover, an advantage of the present invention is to provide a system and a method for managing construction project bids and/or unit pricing data that utilize registration information to create searchable business cards.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of interconnected computers and a database in an embodiment of the present invention.

FIGS. 2, 3, 4A, 4B, 4C, 4D, 5A, 5B and 6 illustrate screen shots of a web application in an embodiment of the present invention.

FIG. 7 illustrates a flowchart of a method in an embodiment of the present invention.

### DETAILED DESCRIPTION OF THE PRESENTLY PREFERRED EMBODIMENTS

The present invention generally relates to a system and a method for managing construction project bids and/or unit pricing data. More specifically, the present invention relates to an online system that manages bids for components of a construction project and allows a registered user to search aggregated unit pricing information. The registered user may be a bidder or a solicitor and may search construction cost information to obtain product and job-specific pricing.

Referring now to the drawings wherein like numerals refer to like parts, FIG. 1 generally illustrates a system 1 for managing construction project bids and/or unit pricing data. The system 1 may have a data communication network 5 (hereinafter “the network 5”) having terminals 10, 11, 12 (hereinafter “terminals 10-12”) connected thereto and in communication therewith. Further, the network 5 may have a server 20 that may be associated with a database 21. The server 20 may be remote relative to the terminals 10-12.

The network 5 may be any type of data communication network that may connect one or more of the terminals 10-12. Any number of terminals may be connected to the network 5, and the present invention is not limited to a specific number of terminals. The network 5 may be, for example, the internet wherein remote computers are connected and/or in communication via a telephone network, broadband network, a wireless network and/or other like network. The network 5 may be any data communication network known to one skilled in the art.

In a preferred embodiment, the database 21 may be web-accessible. Further, the database 21 may be accessible via a web application 30 (hereinafter “the application 30”) associated with the database 21. The application 30 may enable a user to enter construction bid information into the database 21 and/or to obtain the construction bid information from the database 21 as described in more detail hereafter. The database 21 may be accessed via a single web application or via multiple web applications that may be linked to the database 21.

The server 20 may be associated with and/or in communication with the database 21. Users may utilize any of the terminals 10-12 or any other computer connected via the network 5 to access the database 21 through the network 5. One or more of the users may input the construction bid information into the database 21. One or more of the users of the database 21 may use any of the terminals 10-12 and/or any other terminal connected to the network 5 to access and/or to obtain the construction bid information from the database 21. The network 5 may provide real-time updates to the construction bid information and/or access to the real-time updates.

In a preferred embodiment, the users may input and/or may access the construction bid information via the application 30. The users may access and/or may retrieve the application 30 from the server 20 via the network 5. For example, the users may access and/or may retrieve the application 30 using a web browser located on any of the terminals 10-12 connected to the network 5.

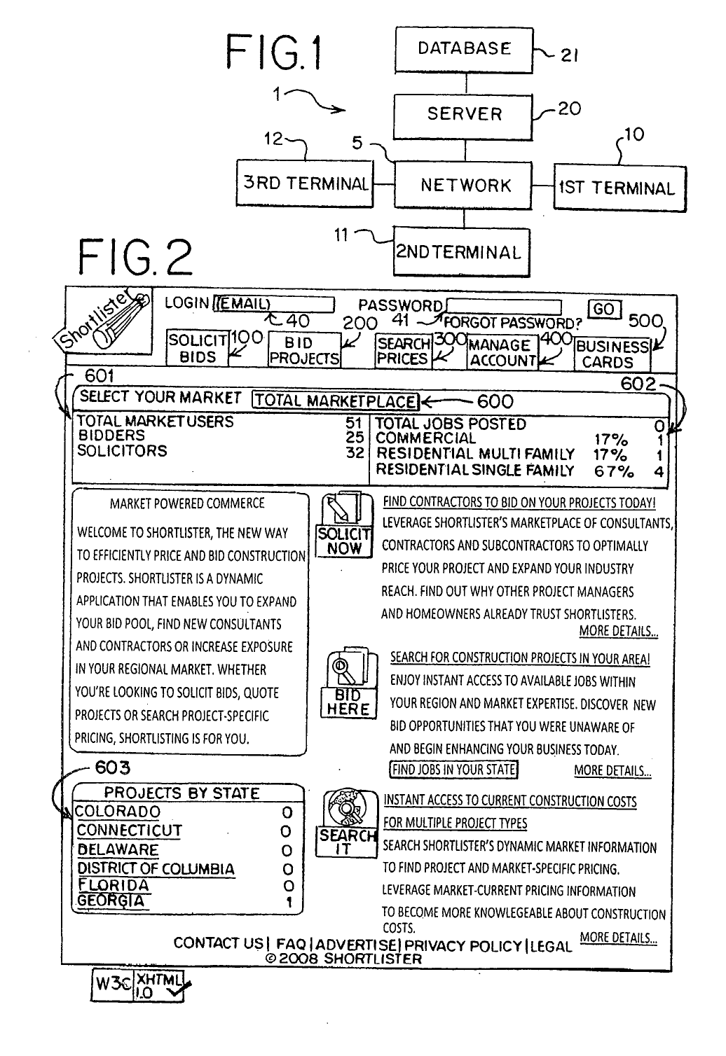

FIG. 2 generally illustrates a screen shot of the application 30 of the system 1 for managing construction project bids and/or unit pricing data. The network 5, the server 20 and/or the database 21 may be designed and/or may be programmed to provide the application 30. The present invention is not limited to a specific embodiment of the application 30.

The system 1, the database 21, the server 20 and/or the application 30 may be designed and/or programmed to enable the user to post a construction project for solicitation of bids on the system 1, in the application 30 and/or in the database 21. The server 20, the database 21, the system 1 and/or the application 30 may be designed and/or may be programmed to require the user to input a username and/or a password into a username entry area 40 and/or a password entry area 41, respectively, to post the construction project.

The system 1 and/or the application 30 may provide the username and/or the password if the user provides registration details, such as, for example, a name, a use of the system 1 and/or the application 30, a postal address, an email address, a telephone number, a telefax number, a company name and/or the like. The use for the system 1 and/or the application 30 may be, for example, “bid on projects,” “solicit bids,” “search database” and/or the like.

The system 1 and/or the application 30 may be programmed and/or may be designed to ask the user if the registration details may be used for a business card. If the user provides input that indicates that the registration details may be used for the business card, the system 1, the server 20, the database 21 and/or the application 30 may generate the business card having the registration details and/or may provide the business card to other users. For example, the system 1, the server 20, the database 21 and/or the application 30 may provide a “business cards” option 500 that may enable other users to search and/or view the business cards.

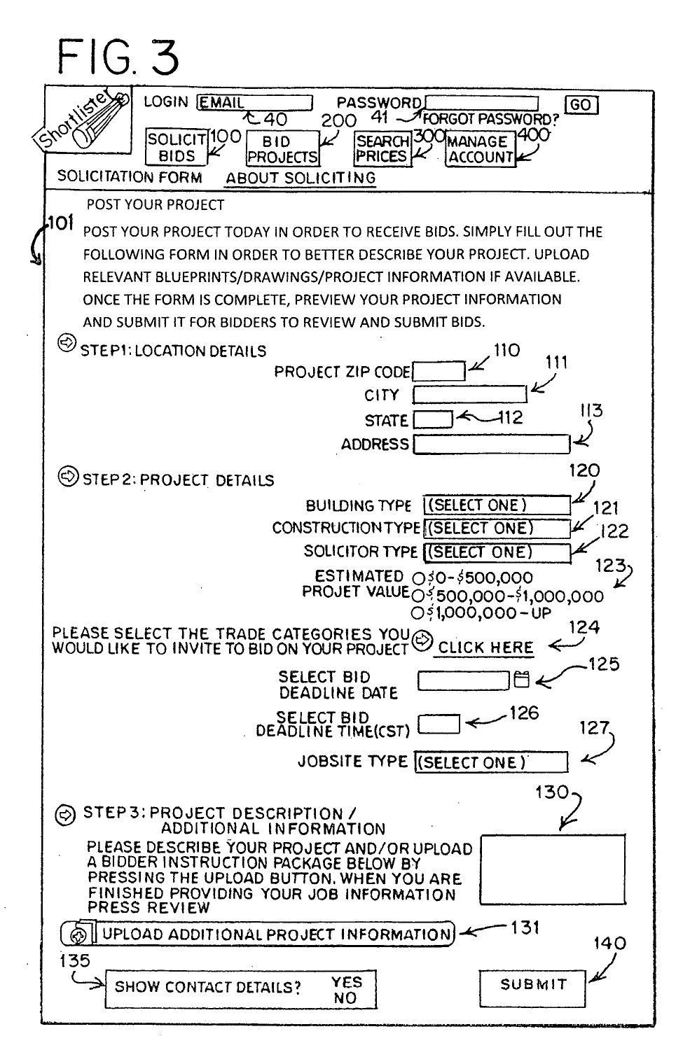

The construction project may be posted on the system 1 and/or the application 30 by selecting a “solicit bids” option 100 provided by the application 30 and/or the system 1. If the user selects the “solicit bids” option 100, the user may proceed to a project entry step. A project entry screen 101 that may be associated with the project entry step is generally depicted in FIG. 3, and the project entry step is described in more detail hereafter.

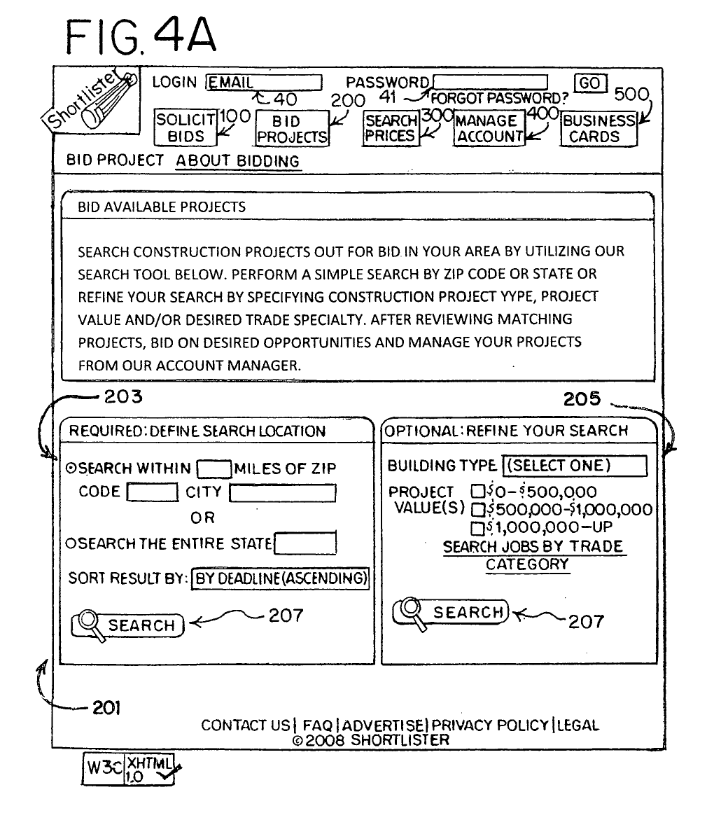

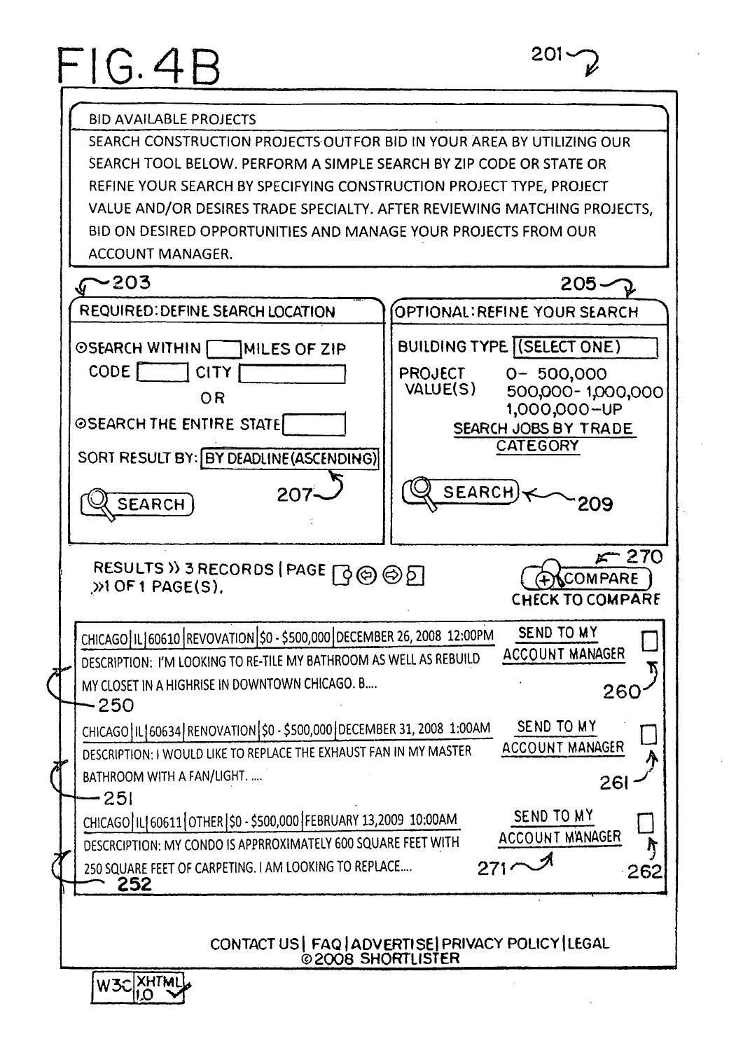

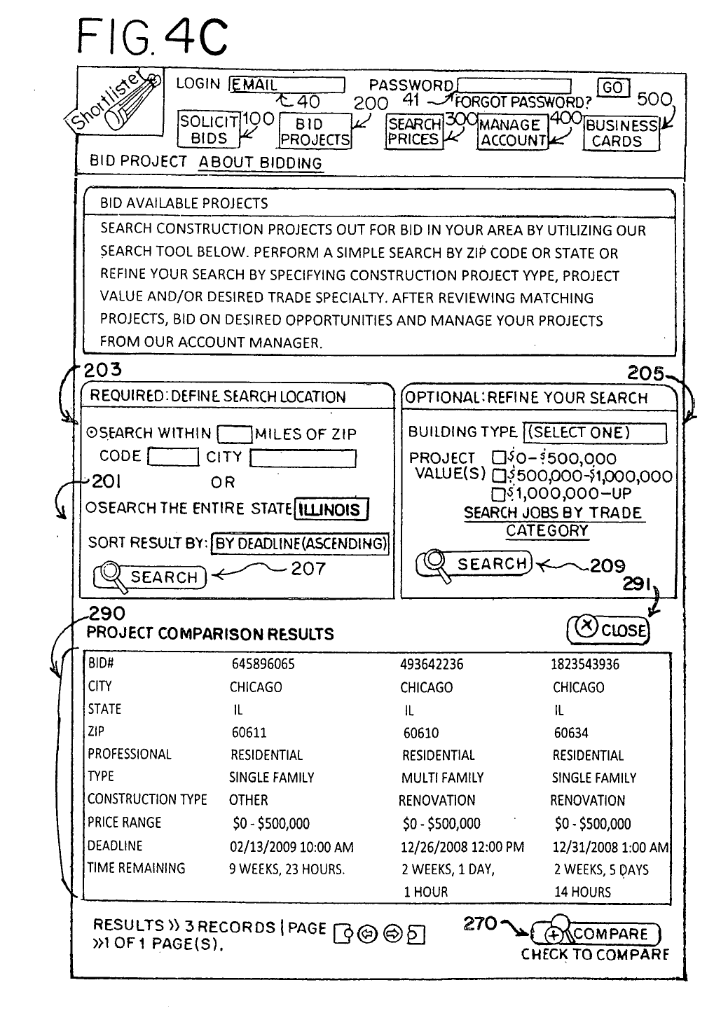

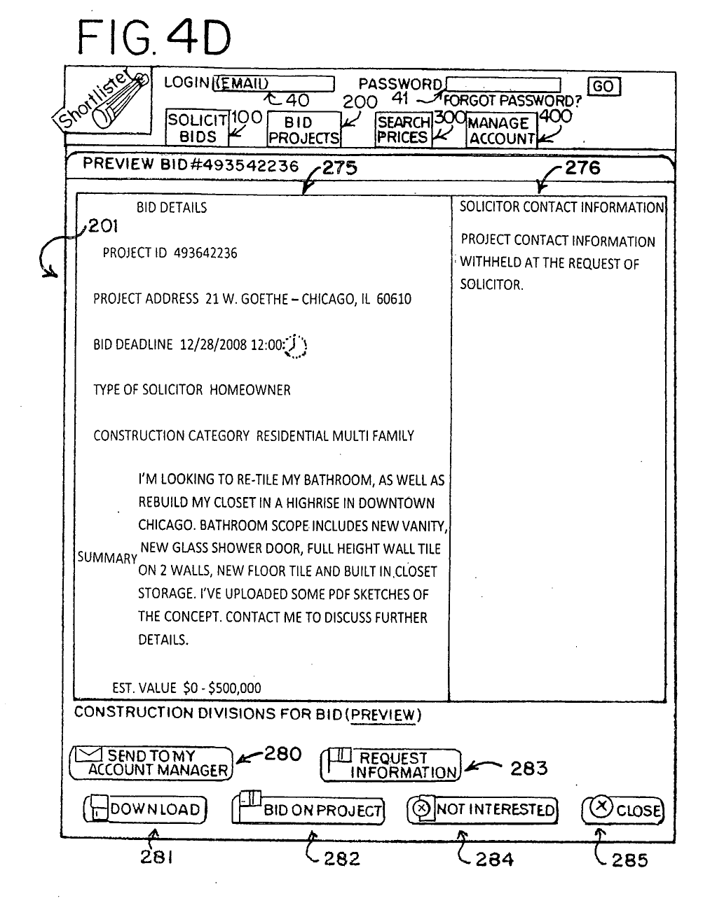

The system 1, the database 21, the server 20 and/or the application 30 may be designed and/or may be programmed to enable the user to search construction projects and/or bid on one or more of the construction projects posted on the system 1, in the application 30 and/or in the database 21. The system 1, the database 21, the server 20 and/or the application 30 may be designed and/or may be programmed to require the user to input the username and/or the password into the username entry area 40 and/or the password entry area 41, respectively, to search construction projects and/or bid on one or more of the construction projects. The construction projects may be searched and/or may be bid upon by selecting a “bid projects” option 200 provided by the application 30 and/or the system 1. If the user selects the “bid projects” option 200, the user may proceed to a project searching/bidding step. A project searching/bidding screen 201 that may be associated with the project searching/bidding step is generally depicted in FIG. 4, and the project searching/bidding step is described in more detail hereafter.

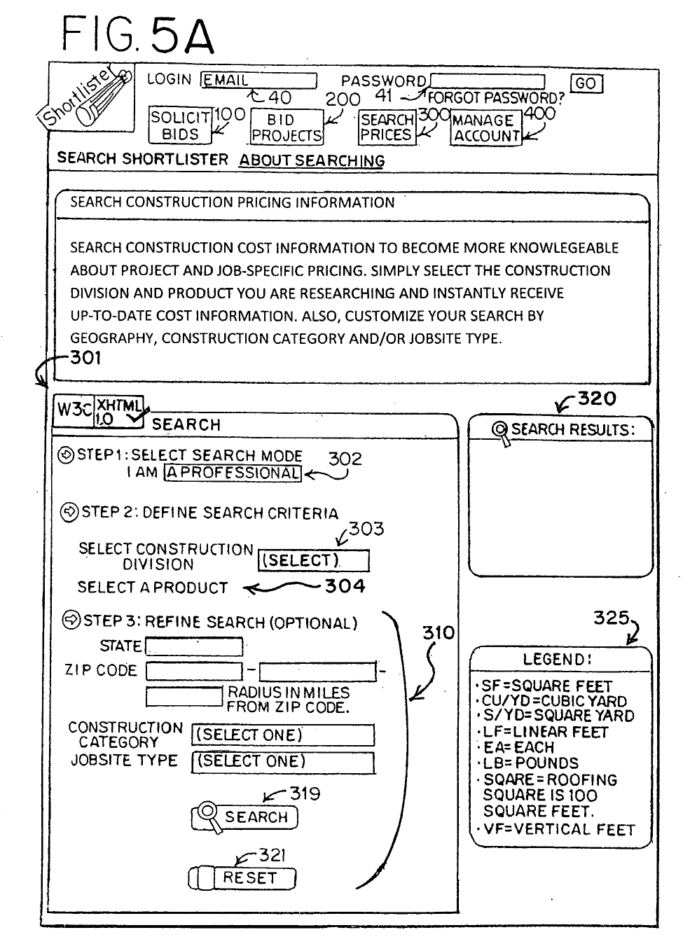

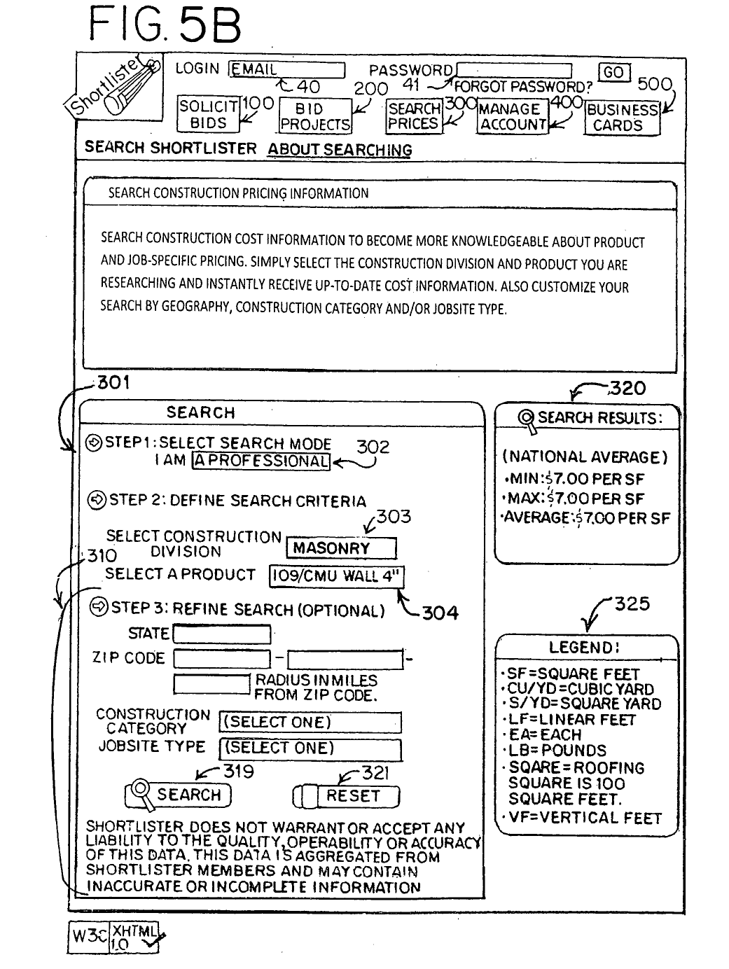

The system 1, the database 21, the server 20 and/or the application 30 may be designed and/or may be programmed to enable the user to determine and/or to search unit pricing data. The unit pricing data may be searched and/or may be determined by selecting a “search prices” option 300 provided by the application 30 and/or the system 1. If the user selects the “search prices” option 300, the user may proceed to a data searching step. A data searching screen 301 that may be associated with the data searching step is generally depicted in FIG. 5, and the data searching step is described in more detail hereafter. The system 1, the database 21, the server 20 and/or the application 30 may be designed and/or may be programmed to require the user to input the username and/or the password into the username entry area 40 and/or the password entry area 41, respectively, to search the unit pricing data.

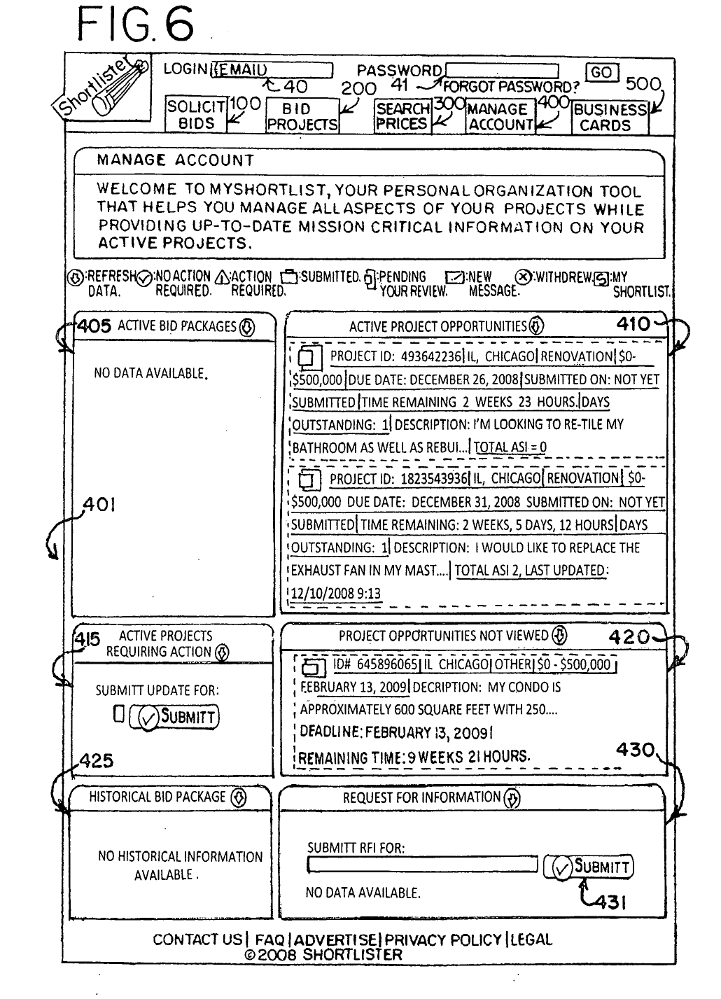

The system 1, the database 21, the server 20 and/or the application 30 may be designed and/or may be programmed to enable the user to manage the construction projects posted by the user and/or the bids entered by the user. The construction projects posted by the user and/or the bids entered by the user may be managed by an account manager and/or selection of a “manage account” option 400 provided by the application 30 and/or the system 1. If the user selects the “manage account” option 400, the user may proceed to an account management step and/or the account manager. An account management screen 401 that may be associated with the account management step is generally depicted in FIG. 6, and the account manager and the management step is described in more detail hereafter. The system 1, the database 21, the server 20 and/or the application 30 may be designed and/or may be programmed to require the user to input the username and/or the password into the username entry area 40 and/or the password entry area 41, respectively, to manage the construction projects posted by the user and/or the bids entered by the user.

The system 1, the database 21, the server 20 and/or the application 30 may be designed and/or may be programmed to indicate a number of users of the system 1. The system 1, the database 21, the server 20 and/or the application 30 may be designed and/or may be programmed to display a number of users box 601 that may display a total number of users, a number of bidders and/or a number of solicitors. The system 1, the database 21, the server 20 and/or the application 30 may be designed and/or may be programmed to display a marketplace restriction box 600 that may be used to restrict the total number of users, a number of bidders and/or a number of solicitors displayed by the number of users box 601 to a geographic area.

For example, the system 1 and/or the application 30 may initially display the total number of users, the number of bidders and/or the number of solicitors worldwide in the number of users box 601. The user may input a geographic area into the marketplace restriction box 600. For example, the user may input “Illinois” into the marketplace restriction box 600. In response, the system 1 and/or the application 30 may display the total number of users, the number of bidders and/or the number of solicitors in Illinois in the number of users box 601.

The system 1, the database 21, the server 20 and/or the application 30 may be designed and/or may be programmed to indicate a number of projects posted in the system 1. For example, the system 1 and/or the application 30 display a number of projects box 602 that may display a total number of projects, a number of retail projects, a number of industrial projects, a number of commercial projects, a number of residential multi-family projects, a number of residential single family projects and/or the like. The marketplace restriction box 600 may be used to restrict the total number of projects, the number of retail projects, the number of industrial projects the number of commercial projects, the number of residential multi-family projects and/or the number of residential single family projects displayed by the number of projects box 602 to a geographic area.

For example, the system 1 and/or the application 30 may initially display the total number of projects, the number of retail projects, the number of industrial projects the number of commercial projects, the number of residential multi-family projects, the number of residential single family projects and/or the like located in the United States of America in the number of projects box 602. The user may input a geographic area into the marketplace restriction box 600. For example, the user may input “Iowa” into the marketplace restriction box 600. In response, the system 1 and/or the application 30 may display the total number of projects, the number of retail projects, the number of industrial projects, the number of commercial projects, the number of residential multi-family projects and/or the number of residential single family projects located in Iowa in the number of users box 601.

The system 1, the database 21, the server 20 and/or the application 30 may be designed and/or may be programmed to indicate projects by state. For example, the system 1 and/or the application may display a projects by state box 603 that displays each of the states of the United States of America adjacent to a number of construction projects posted that are located in the state.

The system 1, the server 20, the database 21 and/or the application 30 may utilize the total number of projects, the number of retail projects, the number of industrial projects, the number of commercial projects, the number of residential multi-family projects, the number of residential single family projects and/or the like located in geographic areas to generate a construction activity map. For example, the construction activity map may have a red area where the total number of projects is high relative to other geographic areas. As a further example, the construction activity map may have a white area where the total number of projects is low relative to other geographic areas. The present invention is not limited to specific embodiments of graphic representations in the construction activity map.

The system 1 and/or the application 30 may restrict the construction activity map to a type of construction, such as, for example, retail projects, industrial projects, commercial projects, residential multi-family projects, residential single family projects and/or the like. For example, the construction activity map may display a first color, such as, for example, green, where the total number of residential single family projects is high relative to other geographic areas. As a further example, the construction activity map may display a second color, such as, for example, red, where the total number of residential single family projects is low relative to other geographic areas.

The construction activity map may also indicate a total number of bids, a number of bids for retail projects, a number of bids for industrial projects, a number of bids for commercial projects, a number of bids for residential multi-family projects, a number of bids for of residential single family projects and/or the like. Alternatively, a bid activity map distinct from the construction activity map may also indicate a total number of bids, a number of bids for retail projects, a number of bids for industrial projects, a number of bids for commercial projects, a number of bids for residential multi-family projects, a number of bids for of residential single family projects and/or the like. For example, the construction activity map may have a first color, such as, for example, green, where the total number of bids on commercial projects is high relative to other geographic areas. As a further example, the construction activity map may have a second color, such as, for example, red, where the total number of commercial projects is low relative to other geographic areas.

FIG. 3 generally illustrates a screen shot of the project entry screen 101 of the application 30 of the system 1 for managing construction project bids and/or unit pricing data. The network 5, the server 20, the database 21 and/or the application 30 may be designed and/or may be programmed to provide the project entry screen 101. The present invention is not limited to a specific embodiment of the project entry screen 101.

The server 20, the database 21, the system 1 and/or the application 30 may be designed and/or may be programmed to provide an electronic form on the application 30 for posting the construction project. The user posting the construction project may input project information using the electronic form of the application 30. The electronic form for posting the construction project may be a section of the application 30 that may have input boxes in which the project information may be typed by the user and/or menus in which the project information may be selected by the user.

The project information for the construction project may be, for example, location details, project details and/or a project description. The location details may be, for example, a project zip code, a city, a state and/or an address. The system 1 and/or the application 30 may be designed and/or may be programmed to provide a zip code entry area 110, a city entry area 111, a state entry area 112 and/or an address entry area 113 for input of the location details. The zip code entry area 110, the city entry area 111, the state entry area 112 and/or the address entry area 113 may be utilized to transmit the location details to the system 1, the server 20 and/or the database 21. The present invention is not limited to a specific embodiment of the location details.

The project details may be, for example, a building type, a construction type, a solicitor type, an estimated project value, trade categories desired, a bid deadline date, a bid deadline time and/or a jobsite type. The building type may be, for example, commercial, industrial, retail, residential single family, residential multi-family, institutional and/or other building type. The construction type may be, for example, new construction, renovation and/or other construction type. The solicitor type may be, for example, architect, building owner, engineer, facility manager, general contractor and/or homeowner. The estimated project value may be, for example, $0.00 to $500,000.00; $500,000.00 to $1,000,000.00; or $1,000,000.00 and above. The jobsite type may be, for example, union, non-union or other. The present invention is not limited to a specific embodiment of the project details.

The system 1 and/or the application 30 may be designed and/or may be programmed to provide a building type menu 120, a construction type menu 121, a solicitor type menu 122, an estimated project value menu 123, a bid deadline date entry area 125, a bid deadline time entry area 126 and/or a jobsite type menu 127 for entry of the project details. The building type menu 120, the construction type menu 121, the solicitor type menu 122, the estimated project value menu 123, the bid deadline date entry area 125, the bid deadline time entry area 126 and/or the jobsite type menu 127 may be utilized to transmit the project details to the system 1, the server 20 and/or the database 21.

The trade categories desired may be, for example, general contractor, site construction, concrete, masonry, metals, wood and plastics, thermal and moisture protection, door and windows, finishes, equipment, furnishings, special construction, conveying system, electrical, mechanical and/or handyman. Each of the trade categories desired may have sub-categories desired.

The system 1 and/or the application 30 may be designed and/or may be programmed to provide a trade categories desired menu 124 for selection of one or more of the trade categories desired. The trade categories displayed in the trade categories desired menu 124 may be simplified and/or may be reduced in number if the solicitor is a homeowner. For example, if the solicitor type menu 122 is utilized to indicate that the solicitor is a homeowner, the trade categories desired menu 124 may display a simplified list of the trade categories to the user. For example, the simplified list may have fewer displayed trade categories relative to a list of the trade categories displayed to a general contractor, an architect and/or the like by the trade categories desired menu 124.

The trade categories desired menu 124 may also enable the user to select one or more of the sub-categories desired for each selected trade category desired. The trade categories desired menu 124 may be utilized to transmit selected trade categories desired and/or selected sub-categories desired to the system 1, the server 20 and/or the database 21. The present invention is not limited to a specific embodiment of the trade categories desired or the sub-categories desired.

The sub-categories desired for the general contractor category may be, for example, General Contractors, Kitchen Remodelers, Basement Remodelers, Professional Home Remodelers, Temporary Facilities and Controls, Detached Garages, Decks And Porches, Cleaning Contractors, Demolition Contractors, Facility Operation, Environmental and Disaster Contractors, Mold Remediation and/or Facility Decommissioning. The sub-categories desired for the site construction category may be, for example, Site Remediation; Site Preparation; Earthwork; Tunneling; Boring and Jacking; Utility Services; Drainage and Containment; Bases, Ballasts, Pavements And Appurtenances; Site Improvements and Amenities; Planting; and/or Site Restoration and Rehabilitation. The sub-categories desired for the concrete category may be, for example, Stucco Systems, Concrete Forms and Accessories, Concrete Reinforcement, Cast In Place Concrete, Precast Concrete, Cementitious Decks and Underlayment, Grouts, Mass Concrete and/or Concrete Restoration and Cleaning.

The sub-categories desired for the masonry category may be, for example, Masonry Units, Stone, Refractories, Corrosion Resistant Masonry, Simulated Masonry, Masonry Assemblies and/or Masonry Restoration and Cleaning. The sub-categories desired for the metals category may be, for example, Structural Metal Framing, Metal Joists, Metal Decks, Cold Formed Metal Framing, Metal Fabrications, Hydraulic Fabrications, Ornamental Metals, Expansion Control and/or Metal Restoration and Cleaning. The sub-categories desired for the woods and plastics category may be, for example, Rough Carpentry, Finish Carpentry, Architectural Woodwork, Structural Plastics, Plastic Fabrications, Wood and Plastic Restoration and Cleaning.

The sub-categories desired for the thermal and moisture protection category may be, for example, Stucco Systems, Damproofing and Waterproofing, Thermal Protection, Shingles, Roof Tiles and Coverings, Roofing and Siding Panels, Membrane Roofing, Flashing and Sheet Metals, Roof Specialties and Accessories, Fire and Smoke Protection and/or Joint Sealers. The sub-categories desired for the doors and windows category may be, for example, Metal Doors and Frames, Wood and Plastic Doors, Specialty Doors, Entrances and Storefronts, Windows, Skylights, Hardware, Glazing, Sunrooms and/or Glazing Curtain Wall.

The sub-categories desired for the finishes category may be, for example, Metal Support Assemblies, Plaster and Gypsum Board, Tile, Terrazzo, Ceilings, Flooring, Wall Finishes, Acoustical Treatment and/or Paints and Coatings. The sub-categories desired for the specialties category may be, for example, Visual Display Boards; Compartments and Cubicles; Service Walls; Grilles and Screens; Louvers and Vents; Wall and Corner Guards; Access Flooring; Pest Control; Fireplaces and Stoves; Identification Devices; Lockers; Fire Protection Specialties; Protective Covers; Postal Specialties; Partitions; Storage Shelving; Exterior Protection; Telephone Specialties; Toilet, Bath and Laundry Specialties; and/or Wardrobes and Closet Specialties.

The sub-categories desired for the equipment category may be, for example, Maintenance Equipment; Security and Vault Equipment; Teller and Service Equipment; Ecclesiastical Equipment; Instrumental Equipment; Registration Equipment; Checkroom Equipment; Mercantile Equipment; Commercial Laundry and Dry Cleaning Equipment; Vending Equipment; Audio-Visual Equipment; Vehicle Service Equipment; Parking Control and Equipment; Loading Dock Equipment; Solid Waste Handling and Disposal; Detention Equipment; Water Supply and Treatment Equipment; Hydraulic Gates and Valves; Fluid Waste Treatment and Disposal Equipment; Food Service Equipment; Residential Equipment; Unit Kitchens; Darkroom Equipment; Athletic, Recreational And Therapeutic Equipment; Industrial and Process Equipment; Laboratory Equipment; Planetarium Equipment; Observatory Equipment; Office Equipment; Medical Equipment; Mortuary Equipment; Navigation Equipment; Agricultural Equipment; and/or Exhibit Equipment.

The sub-categories desired for the furnishings category may be, for example, Fabrics, Art, Manufactured Casework, Furnishings and Accessories, Furniture, Multiple Seating, Systems Furniture, Interior Plants and Planters and/or Furnishings Restoration and Repair. The sub-categories desired for the special construction category may be, for example, Air-Supported Structures; Building Modules; Special Purpose Rooms; Sound, Vibration, and Seismic Control; Radiation Protection; Lighting Protection; Cathodic Protection; Pre-Engineered Structures; Swimming Pools; Aquariums; Aquatic Parks and Facilities; Tubs and Pools; Ice Rinks; Kennels and Animal Shelters; Site Constructed Incinerators; Storage Tanks; Filter Underdrains and Media; Digester Covers and Appurtenances; Oxygenated Systems; Sludge Conditioning Systems; Hazardous Material Remediation; Measure and Control Instrumentation; Recording Instrumentation; Transportation Control Instrumentation; Solar and Wind Energy Equipment; Security Access and Surveillance Equipment; Building Automation and Control; Detection and Alarm; and/or Fire Suppression.

The sub-categories desired for the conveying system category may be, for example, Dumbwaiters, Elevators, Escalators and Moving Walks, Lifts, Materials Handling, Hoists and Cables, Turntables, Scaffolding and Transportation. The sub-categories desired for the mechanical category may be, for example, Basic Mechanical Materials and Methods; Building Service Piping; Process Piping; Fire Protection Piping; Plumbing Fixtures and Equipment; Heat Generation Equipment; Refrigeration Equipment; Heating, Ventilation and Air Conditioning Equipment; Air Distribution; HVAC Instrumentation And Controls; and/or Testing, Adjusting and Balancing. The sub-categories desired for the electrical category may be, for example, Basic Electrical Materials and Methods, Wiring Methods, Electrical Power, Transmission and Distribution, Low-Voltage Distribution, Lighting Protection, Communications and/or Sound and Video.

The system 1 and/or the application 30 may be programmed and/or may be designed so that the trade categories desired menu 124 may enable the user to select any number and/or any combination of the trade categories desired and/or the sub-categories. For example, the user may utilize the trade categories desired menu 124 to select the general contractor category, the dumbwaiter sub-category of the conveying system category and/or the handyman category. As a further example, the user may utilize the trade categories desired menu 124 to select the cleaning contractors sub-category of the general contractor category, the furnishings category, the swimming pools subcategory of the special construction category and/or the vending equipment sub-category of the special equipment category. The present invention is not limited to a specific number and/or a specific combination of the trade categories desired and/or the sub-categories that may be selected using the categories desired menu 124.

The system 1 and/or the application 30 may be programmed and/or may be designed to enable the user to enter the project description in a project description entry area 130. For example, the user may utilize the project description entry area 130 to input information regarding the project that may not be provided using the zip code entry area 110, the city entry area 111, the state entry area 112, the address entry area 113, the building type menu 120, the construction type menu 121, the solicitor type menu 122, the estimated project value menu 123, the categories desired menu 124, the bid deadline date entry area 125, the bid deadline time entry area 126 and/or the jobsite type menu 127.

The system 1 and/or the application 30 may be programmed and/or may be designed to enable the user to enter additional information about the construction project. For example, the system 1 and/or the application 30 may be programmed and/or may be designed to provide an upload additional information function 131. The user may use the upload additional information function 131 to transfer a file that may have the additional information. The upload additional information function 131 may be utilized to transmit the file to the system 1, the server 20 and/or the database 21.

The system 1 and/or the application 30 may be programmed and/or may be designed to provide a contact details function 135. The user may enter contact details when registering with the system 1 and/or the application 30. The contact details function 135 may enable the user to choose to display the contact details to other users or to not display the contact details to other users. For example, the contact details may be displayed or may not be displayed in association with the construction project posted by the user.

The system 1 and/or the application 30 may be programmed and/or may be designed to provide a submit function 140 that may enable the user to direct the system 1, the application 30, the server 20 and/or the database 21 to store the project information. The system 1, the application 30, the server 20 and/or the database 21 may assign a project identification number to the construction project. The project information may be used to provide the construction project to other users searching and/or bidding using the system 1, the server 20, the database 21 and/or the application 30 as described hereafter.

FIGS. 4A, 4B, 4C and 4D generally illustrate screen shots of the project searching/bidding screen 201 of the application 30 of the system 1 for managing construction project bids and/or unit pricing data. The network 5, the server 20, the database 21 and/or the application 30 may be designed and/or may be programmed to provide the project searching/bidding screen 201. The present invention is not limited to a specific embodiment of the project searching/bidding screen 201.

Referring to FIG. 4A, the server 20, the database 21, the system 1 and/or the application 30 may be designed and/or may be programmed to provide an electronic form on the application 30 for searching for a construction project. The user searching for the construction project may input search information using the electronic form of the application 30. The electronic form for searching for the construction project may be a section of the application 30 that may have input boxes in which the search information may be typed by the user and/or menus in which the search information may be selected by the user.

The search information may be, for example, a zip code, a distance from the zip code, a city, a state, a building type, a project value, a trade category and/or the like. The project value may be, for example, $0.00 to $500,000.00; $500,000.00 to $1,000,000.00; or $1,000,000.00 and above. Input of some of the search information may be optional, and/or input of some of the search information may be required before a project search is performed. The present invention is not limited to a specific embodiment of the search information or means for inputting the search information.

The system 1 and/or the application 30 may be designed and/or may be programmed to provide a search location entry area 203 for entry of the zip code, the distance from the zip code, the city, the state and/or the like. The system 1 and/or the application 30 may be designed and/or may be programmed to provide a search refinement area 205 for entry of the building type, the project value, the trade category and/or the like.

For example, the search refinement area 205 may be utilized to search for the projects that have the trade categories desired and/or the sub-categories desired. For example, the user may utilize the search refinement area 205 to select the professional remodelers—homes subcategory of the general contractor category, the doors and windows category, the visual display boards subcategory of the specialties construction category and/or the handyman category. The system 1 and/or the application 30 may be programmed and/or may be designed so that the user may search for any number and/or any combination of the trade categories and/or the sub-categories.

After the search information is entered into the project searching/bidding screen 201, the user may select a search button 207 to initiate the search. The system 1, the server 20, the database 21 and/or the application 30 may be designed and/or may be programmed to display the search button 207. The search location entry area 203, the search refinement area 205 and/or the search button 207 may be utilized to transmit the search information to the system 1, the server 20 and/or the database 21.

FIG. 4B generally illustrates a screen shot of the project searching/bidding screen 201 after the application 30, the system 1, the server 20 and/or the database 21 performs the search. The application 30, the system 1, the server 20 and/or the database 21 may perform the search by comparing the search information to the project information that may be stored in the database 21. The application 30, the system 1, the server 20 and/or the database 21 may display search results that may be construction projects that have project information that matches and/or corresponds to the search information. The application 30, the system 1, the server 20 and/or the database 21 may list the projects and/or the project information in the account manager as discussed in further detail hereafter.

In the previous example where the user utilized the search refinement area 205 to select the professional remodelers—homes subcategory of the general contractor category, the doors and windows category, the visual display boards subcategory of the specialties construction category and/or the handyman category, the search results may be the construction projects that have the trade categories desired and/or the sub-categories that match and/or correspond to these trade categories and/or sub-categories selected by the bidder.

The application 30, the system 1, the server 20 and/or the database 21 may display a first search result 250, a second search result 251 and/or a third search result, for example. The first search result 250, the second search result 251 and/or the third search result 253 may be a construction project that has project information that matches and/or corresponds to the search information. The present invention is not limited to a specific embodiment of the project searching/bidding screen 201 or the search results.

The application 30, the system 1, the server 20 and/or the database 21 may be programmed and/or designed to provide a send to account manager function 271. The user may select the send to account manager function 271 to store and/or list the construction project and/or the project information in the account manager as discussed in further detail hereafter. In an embodiment, the construction project and/or the project information associated with the search results may be automatically stored and/or listed in the account manager by the system 1 and/or the application 30.

The application 30, the system 1, the server 20 and/or the database 21 may provide a compare projects function 270. The project details of the search results may be displayed and/or may be compared if the compare projects function 270 is selected. The application 30, the system 1, the server 20 and/or the database 21 may provide selection boxes next to the search results that enable two or more search results to be selected for use with the compare projects function 270. For example, the application 30, the system 1, the server 20 and/or the database 21 may provide a first search result selection box 260, a second search result selection box 261 and/or a third search result selection box 262. If the first search result selection box 260, the second search result selection box 261 and/or the third search result selection box 262 are selected, the project details for the first search result 250, the first search result 251 and/or the first search result 252, respectively, may be displayed in a project comparison box 290.

FIG. 4C generally illustrates a screen shot of the project searching/bidding screen 201 if the application 30, the system 1, the server 20 and/or the database 21 displays the project comparison box 290. For example, the project comparison box 290 may display the project identification number, the city, the state, the zip code, the building type, the construction type, the estimated project value, the bid deadline date, the bid deadline time, a time remaining to bid and/or the like. The application 30, the system 1, the server 20 and/or the database 21 may provide a close function 291 that may return the user to the search results. The present invention is not limited to a specific embodiment of the project comparison box 290. The project comparison box 290 may have any combination of selected search results and/or may display any of the project details for each of the selected search results.

Referring again to FIG. 4B, if the user selects one of the search results, the application 30, the system 1, the server 20 and/or the database 21 may display the project information associated with the selected search result. For example, as generally illustrated in FIG. 4D, the application 30, the system 1, the server 20 and/or the database 21 may display the project information associated with the selected search result in a bid details box 275. The present invention is not limited to a specific embodiment of the bid details box 275.

For example, the application 30, the system 1, the server 20 and/or the database 21 may display the project identification number, the project address, the bid deadline, the type of solicitor, the construction category, the product description and/or the estimated value associated with the selected search result. The application 30, the system 1, the server 20 and/or the database 21 may display a solicitor information box 276 that may have the contact details associated with the user who posted the construction project. Alternatively, the solicitor information box 276 may not display the contact details associated with the user who posted the construction project. For example, the user who posted the construction project may use the contact details function 135 to direct the system 1 and/or the application 30 to not display the contact details.

The application 30, the system 1, the server 20 and/or the database 21 may be programmed and/or may be designed to display a send to account manager function 280, a download function 281, a bid on project function 282, a request information function 283, a not interested function 284 and/or a close function 285. If the send to account manager function 280 is selected, the application 30, the system 1, the server 20 and/or the database 21 may provide the construction project and/or the project details to an account manager of the user bidding on the project as described hereafter. If the download function 281 is selected, the application 30, the system 1, the server 20 and/or the database 21 may transmit the construction project and/or the project details to a terminal of the user for local storage and/or storage as a file on the terminal.

If the request information function 283 is selected, the application 30, the system 1, the server 20 and/or the database 21 may enable the user to enter a request for information. The system 1 and/or the application 30 may transmit the request for information to the user that posted the construction project as an email, a text message, a message in the account manager of the user that posted the construction project and/or the like. If the not interested function 284 is selected, the system 1, the server 20 and/or the database 21 may prevent addition of the construction project to the account manager of the user, may remove the construction project from the account manager of the user and/or may return the user to the search results. If the close function 285 is selected, the system 1, the server 20 and/or the database 21 may return the user to the search results.

If the bid on project function 282 is selected, the application 30, the system 1, the server 20 and/or the database 21 may enable the user to enter a bid on the construction project. If the bid on project function 282 is selected, the application 30, the system 1, the server 20 and/or the database 21 may enable the user to upload quote details as a file. The quote details may be, for example, conditions for proposed work and/or goods, an explanation of how the bid was calculated and/or the like. The system 1 and/or the application 30 may transmit the bid on the construction project and/or the quote details to the user that posted the construction project as an email, a text message, a message in the account manager of the user that posted the project and/or the like.

The user that receives the bid may decline or may accept the bid. The system 1 and/or the application 30 may enable the user to decline or accept the bid using the account management screen 401 as discussed hereafter. The system 1 and/or the application 30 may transmit a message to the user that provided the bid that indicates that the user that posted the construction project declined or accepted the bid. The message may be, for example, an email, a text message, a message in the account manager of the user that provided the bid and/or the like.

The user may receive a discount offer if the user presents a bid, presents a bid that is accepted, posts a construction project, posts a construction project that accepts a bid and/or the like. The discount offer may be a discount for purchasing materials and/or services. The discount offer may be a future promotional offer that may be used during specified dates in the future. For example, the specified dates of the future promotional offer may be established and/or determined so that the future promotional offer may be used for a subsequent construction project.

The materials and/or the services of the discount offer may be based on the trade category and/or the sub-category. For example, if the user presents a bid associated with the masonry trade category, the system 1 and/or the application 30 may provide a discount offer for reinforced concrete slabs. As a further example, if the user posts a construction project that requires the doors and windows trade category, the system 1 and/or the application 30 may provide a discount offer for hollow metal doors. Therefore, the discount offer may enable targeted marketing such that the discount offer is provided to the users that may be likely to purchase the materials and/or the services with which the discount offer is associated. The discount offer may be, for example, a redemption number provided at a time of purchase, a printable coupon and/or the like. The present invention is not limited to a specific embodiment of the discount offer.

A provider of the system 1 and/or the application 30 may receive compensation for a purchase by the user having the discount offer. For example, in the previous example, if the user purchases the hollow metal doors using the discount offer, the provider may receive compensation from a seller of the hollow metal doors. The compensation may be based on an amount of the materials and/or the services purchased with the discount offer, an amount of profit from the purchase for the seller and/or the like.

The user that receives the bid may provide feedback information regarding the user that presented the bid to the system 1, the server 20, the database 21 and/or the application 30. The system 1, the server 20, the database 21 and/or the application 30 may be designed and/or may be programmed to accept, to aggregate and/or to store the feedback information regarding the user that presented the bid. The feedback information regarding the user that presented the bid may be, for example, comments regarding the bid, comments regarding the quote details and/or the like. The feedback information regarding the user that presented the bid may be displayed to other users of the system 1 and/or the application 30 when the other users receive a bid from the user.

The user that presents the bid may provide feedback information regarding the user that posted the construction project to the system 1, the server 20, the database 21 and/or the application 30. The system 1, the server 20, the database 21 and/or the application 30 may be designed and/or may be programmed to accept and/or to aggregate the feedback information regarding the user that posted the construction project. The feedback information may be displayed to other users of the system 1 and/or the application 30 when the other users view other construction projects posted by the user. The present invention should not be limited to a specific embodiment of the feedback information regarding the user that presented the bid and/or the feedback information regarding the user that posted the construction project.

The system 1, the server 20, the database 21 and/or the application 30 may be designed and/or may be programmed to generate a ranking for one or more of the users. The ranking may be displayed on the application 30 when the other users receive a bid from the user and/or when the other users view other construction projects posted by the user. The ranking may be based on the feedback information and/or other factors. For example, the other factors may be a number of construction projects posted, a number of bids presented, a number of bids accepted, a number of bids declined and/or the like. The present invention is not limited to a specific embodiment of the ranking.

The system 1 and/or the application 30 may provide the user that presents the bid with a product-pricing survey of specific materials and/or services. The product-pricing survey may be based on the trade categories and/or the sub-categories involved in the bid of the user. For example, if the user selected the general contractor trade category, the product-pricing survey may inquire about pricing of general contractor services, such as, for example, interior renovation, addition, new construction and/or the like for multi-family residential, single family residential, commercial, industrial, institutional, retail construction projects and/or the like.

As a further example, if the user selected the site construction trade category, the product-pricing survey may inquire about pricing of materials and/or services associated with site construction, such as, for example, sod stripping, underpinning, dewatering, sheet piling, soil stabilization, reinforced earth, cuts and fills, place and compact, rough grading, dirt and soil disposal, excavation and backfill, PVC pipe, concrete pipe, clay pipe, bituminous pipe, asphalt pavement, concrete pavement, precast concrete pavement, unit pavers—concrete, unit pavers—masonry, concrete curbs and gutters, signage and stripping, pressed or stamped concrete, porous pavement, irrigation piping, sprinkler heads, area drain, chain link fence, wood fence, trees, shrubs, sod, seed, top soil, fertilizer and/or the like.

As a further example, if the user selected the concrete trade category, the product-pricing survey may inquire about pricing of materials and/or services associated with masonry, such as, for example, reinforced concrete above grade, reinforced concrete foundation, reinforced concrete slabs, reinforced concrete sealants, saw cutting, structural T's, hollow core planks, architectural panels, tilt slabs, glass fiber reinforced concrete wall panels, self leveling topping, ready mixed material, concrete staining, power washing, stucco systems and/or the like.

As a further example, if the user selected the metals trade category, the product-pricing survey may inquire about pricing of materials associated with metal work, such as, for example, structural steel frames, structural steel pipe columns, structural steel angles and framing channels, metal decks, cold formed framing, heavy gauge structural, steel stairs, steel railings, stainless steel railings, aluminum railings, bronze railings, metal floor expansion joint covers, metal wall expansion joint covers, metal ceiling expansion joint covers, exterior metal expansion joint covers and/or the like.

As a further example, if the user selected the wood and plastics trade category, the product-pricing survey may inquire about pricing of materials and/or services associated with wood and plastics, such as, for example, platform framing, interior wood stud wall framing, joist framing, floor underlayment, rafter framing, roof sheathing, wall sheathing, post and beam construction, milled hardwood trim, milled softwood trim, wood flooring, wood paneling, wood railings, countertops, cabinetry, wood stairs, decorative railings, architectural fiberglass, architectural foam extrusions—interior, architectural foam extrusions—exterior and/or the like.

As a further example, if the user selected the thermal and moisture protection trade category, the product-pricing survey may inquire about pricing of materials and/or services associated with thermal and moisture protection, such as, for example, hot applied emulsified asphalt, polymerized asphalt damproofing, part polyurethane waterproof membrane, epoxy based waterproof membrane, adjustable pedestal pavers, bentonite waterproofing, cementitious waterproofing, glass fiber boards, foam plastic boards, polyisocyanurate boards, asphalt shingles, steel shingles, fiber cement shingles, clay tile, slate tile, composite plastic, standing seam roof, flat seam roof, insulated panels, composite panels, siding, roof curbs and/or the like.

As a further example, if the user selected the masonry trade category, the product-pricing survey may inquire about pricing of materials and/or services associated with masonry, such as, for example, CMU, brick veneer, limestone veneer, granite veneer, marble veneer, sandstone veneer, slate veneer, CMU wall, insulated CMU wall, simulated stone, split faced block, tuck pointing, power washing, brick painting and/or the like.

As a further example, if the user selected the electrical trade category, the product-pricing survey may inquire about pricing of materials associated with electrical work, such as, for example, outlets, circuit panels, switches, lights and/or the like.

As a further example, if the user selected the doors and windows category, the product-pricing survey may inquire about pricing of materials and/or services associated with doors and windows, such as, for example, hollow metal door and frame, wood double hung, vinyl double hung, metal double hung, sunrooms, typical residential door, typical commercial door, typical institutional door and/or the like.

The present invention is not limited to a specific embodiment of the product-pricing survey. Responses by the user to the product-pricing survey may be aggregated as the unit pricing data which may be stored by the system 1, the server 20, the database 21 and/or the application 30. The unit pricing data may be searched in the data searching step described hereafter.

FIGS. 5A and 5B generally illustrate screen shots of the data searching screen 301 of the application 30 of the system 1 for managing construction project bids and/or unit pricing data. The network 5, the server 20, the database 21 and/or the application 30 may be designed and/or may be programmed to provide the data searching screen 301. The present invention is not limited to a specific embodiment of the data searching screen 301.

Referring to FIG. 5A, the server 20, the database 21, the system 1 and/or the application 30 may be designed and/or may be programmed to provide an electronic form on the application 30 for searching the unit pricing data. The user searching the unit pricing data may input search parameters using the electronic form of the application 30. The electronic form for searching the unit pricing data may be a section of the application 30 that may have input boxes in which the search parameters may be typed by the user and/or menus in which the search parameters may be selected by the user. The search parameters may be, for example, a trade category, a sub-category, a material, a service, a zip code, a city, a state, a time period and/or the like.

The server 20, the database 21, the system 1 and/or the application 30 may be designed and/or may be programmed to provide a search mode box 302. For example, the search mode box 302 may enable the user to select professional mode and/or homeowner mode. The server 20, the database 21, the system 1 and/or the application 30 may be designed and/or may be programmed to provide a construction division box 303. For example, the construction division box 303 may enable the user to indicate a construction division parameter, such as, for example, general contractor, site construction, concrete, masonry, metals, wood and plastics, thermal and moisture protection, door and windows, finishes, equipment, furnishings, special construction, conveying system, electrical and/or mechanical. The server 20, the database 21, the system 1 and/or the application 30 may be designed and/or may be programmed to provide a construction material box 304. For example, the construction material box 303 may enable the user to indicate a construction material parameter, such as, for example, a product, a material and/or the like to be used in a construction project.

The server 20, the database 21, the system 1 and/or the application 30 may be designed and/or may be programmed to provide a construction material box 304. For example, the construction material box 304 may enable the user to indicate a construction material parameter, such as, for example, a product, a material and/or the like to be used in a construction project.

If the user selected the homeowner mode using the search mode box 302, the construction material box 304 may enable the user to type a product name, and/or the system 1 and/or the application 30 may provide materials that have names that match and/or correspond to the name typed by the user. If the user selected the professional mode using the search mode box 302, the construction material box 303 may provide choices of materials, and/or the system 1 and/or the application 30 may enable the user to select from the materials.

For example, the choices of materials displayed by the construction material box 303 may be based on the construction division parameter selected in the construction division box 303. For example, if the construction division parameter selected is finishes, the choices of materials may be drywall, stucco, cement board and/or the like. As a further example, if the construction division parameter selected is specialties, the choices of materials may be toilet stalls, chimneys, lockers, awning, fireplaces and/or the like.

The server 20, the database 21, the system 1 and/or the application 30 may be designed and/or may be programmed to provide a refinement tool 310. For example, the refinement tool 310 may enable the user to indicate an additional parameter, such as, for example, a state, a zip code, a distance from the zip code, a building type, a jobsite type and/or the like. The building type may be, for example, commercial, industrial, institutional, residential single family, residential multi-family, retail and/or the like. The jobsite type may be union, non-union and/or other. The present invention is not limited to a specific embodiment of the search parameters or means for inputting the search parameters.

The server 20, the database 21, the system 1 and/or the application 30 may be designed and/or may be programmed to provide a submit search function 319. The user may select the submit search function 319 to submit the search parameters to the system 1, the server 20, the database 21 and/or the application 30.

FIG. 5B generally illustrates a screen shot of the data searching screen 301 of the application 30 of the system 1 for managing construction project bids and/or unit pricing data after submission of the search parameters. The application 30, the system 1, the server 20 and/or the database 21 may display a search results box 320 that may display the unit pricing data that corresponds to the search parameters input by the user. For example, the search results box 320 may display a minimum cost per unit, a maximum cost per unit and/or an average cost per unit. The search results box 320 may indicate whether the unit pricing data displayed is national data, data for a specific state, data for a specific zip code and/or the like. The system 1 and/or the application 30 may be programmed and/or may be designed to provide a legend 325 to assist the user in understanding the search results box 320, the minimum cost per unit, the maximum cost per unit and/or the average cost per unit. For example, the legend 325 may indicate that “SF=Square Feet,” “CU/YD=Cubic Yard,” “S/YD=Square Yard,” “LF=Linear Feet,” “EA=Each,” “LB=Pounds,” “Square=Roofing Square is 100 Square Feet,” “VF=Vertical Feet” and/or the like.

For example, if the user selects and/or inputs four-inch CMU Wall in the construction material box 304, the search results box 320 may display the minimum cost per unit of $6.00 per square foot, the maximum cost per unit of $8.00 per square foot and/or the average cost per unit of $7.00 per square foot. Further, the search results box 320 may indicate that the unit pricing data displayed is national data. As a further example, if the user selects and/or inputs PVC pipe in the construction material box 304, the search results box 320 may display the minimum cost per unit of $2.00 per linear foot, the maximum cost per unit of $5.00 per linear foot and/or the average cost per unit of $3.00 per linear foot. Further, if the user utilizes the refinement tool 310 to input the search parameter of Illinois, the system 1 and/or the application 30 may restrict the unit pricing data to the unit pricing data provided by bidders located in Illinois. Still further, search results box 320 may indicate a number of bidders that provided the unit pricing data for the selected parameter and/or display contact information for the bidders that provided the unit pricing data for the selected parameter. For example, the contact information may be obtained using the registration details of the bidders that provided the unit pricing data for the selected parameter. In addition, the search results box 320 may indicate that the unit pricing data displayed is unit pricing data for Illinois. The present invention is not limited to a specific embodiment of the search results box 320.

The system 1 and/or the application 30 may be designed and/or may be programmed to provide a reset function 321. Selection of the reset function 321 may clear the construction division box 303, the construction material box 304 and/or the 310 for the user to input new search parameters for a subsequent search by the system 1 and/or the application 30.

The system 1 and/or the application 30 may format the unit pricing data in a database exchange language for input into Building Information Modeling (“BIM”) software. Database exchange languages are programming languages designed to support communication of data and metadata. BIM software is three-dimensional building modeling software that generates and/or manages building data. Typically, BIM software manages building geometry, spatial relationships, geographic information and/or quantities and/or properties of building components. The building components may be, for example, wall assemblies, roof assemblies, other structural assemblies and/or the like. A BIM software user may be, for example, an architect, an engineer and/or the like.

Therefore, input of the unit pricing data into BIM software by the system 1 and/or the application 30 may enable a user of the BIM software to obtain a cost estimate for a structure designed by the BIM software. For example, if the user of the BIM software incorporates a building component into the structure, the unit pricing data for the building component may be used to generate and/or adjust the cost estimate for the structure. More specifically, if the user of the BIS software incorporates a wall assembly into a commercial building, the unit pricing data for the wall assembly may be used to generate and/or adjust the cost estimate for the commercial building, for example.

As discussed previously, the unit pricing data may be restricted to a specific geographic area. Thus, if the user of the BIM software incorporates a building component into a structure being built in California, the unit pricing data for California may be used to calculate, to generate and/or adjust the cost estimate for the structure being built in California.

FIG. 6 generally illustrates a screen shot of the account management screen 401 of the application 30 of the system 1 for managing construction project bids and/or unit pricing data. The network 5, the server 20, the database 21 and/or the application 30 may be designed and/or may be programmed to provide the account management screen 401. The present invention is not limited to a specific embodiment of the account management screen 401.

The system 1, the server 20, the database 21 and/or the application 30 may be designed and/or may be programmed to display an active bid packages box 405. The active bid packages box 405 may display the construction projects posted by the user that have not initiated. The user may select one or more of the construction projects displayed to view the project information associated with the selected construction project. The system 1 and/or the application 30 may remove one or more of the construction projects from the active bid packages box 405 if the construction project posted by the user is initiated.

The system 1 and/or the application 30 may enable the user to decline or accept one of the bids displayed in the active bid packages box 405. For example, the user may select a “decline” function or an “accept” function (not shown). The system 1 and/or the application 30 may transmit a message to the user that provided the bid that indicates that the user that posted the construction project declined or accepted the bid. The message may be, for example, an email, a text message, a message in the account manager of the user that provided the bid and/or the like.

The system 1, the server 20, the database 21 and/or the application 30 may be designed and/or may be programmed to display an active project opportunities box 410. The active project opportunities box 410 may display the search results obtained in the project searching/bidding step, the search results obtained using the project searching/bidding screen 201 and/or the construction projects transmitted to the account manager by use of the send to account manager function 271 and/or the send to account manager function 280. The active project opportunities box 410 may display the project information associated with each of the construction projects displayed. The user may select one or more of the construction projects displayed to view the project information associated with the selected construction project.

If the bid deadline passes for one of the construction projects displayed in the active project opportunities box 410, the system 1 and/or the application 30 may be programmed and/or may be designed to remove the construction project associated with the bid deadline that has passed from the active project opportunities box 410. If the user provides a bid for one or more of the construction projects displayed in the active project opportunities box 410, the system 1 and/or the application 30 may be programmed and/or may be designed to indicate that the bid was entered and/or submitted in the active project opportunities box 410.

The system 1, the server 20, the database 21 and/or the application 30 may be designed and/or may be programmed to display an active projects requiring action box 415. The active projects requiring action box 415 may display the construction projects posted by the user that initiated the construction projects. The user may select one or more of the construction projects displayed to view the project information associated with the selected construction project.

The active projects requiring action box 415 may display specific tasks required for the construction project that initiated. The system 1 and/or the application 30 may be designed and/or may be programmed to enable the user to utilize the active projects requiring action box 415 to send a task update regarding one or more of the specific tasks associated with the construction project. For example, the task updates may be utilized to indicate initiation of the specific task, completion of the specific task, estimated date of initiation of the specific task, estimated completion date of the specific task, a delay in the specific task and/or the like.

For example, the user may be a subcontractor, and/or the user may utilize the active projects requiring action box 415 to send a task update regarding a specific task to the contractor. As a further example, the user may be a mason, and/or the user may utilize the active projects requiring action box 415 to send a task update regarding a specific task to the subcontractor. The system 1 and/or the application 30 may transmit the task update as an email, a text message, a message in the account manager of the user and/or the like. The present invention is not limited to a specific embodiment of the task update.

Therefore, the task updates generated by the active projects requiring action box 415 may enable the user to follow progress of the construction project and/or ensure that steps of the construction project are completed in a proper chronological order. For example, a construction project may have a contractor, a first subcontractor and/or a second subcontractor. The first subcontractor may have a first task, and/or the second subcontractor may have a second task that may only be initiated after the first task is completed. After the first subcontractor completes the first task, the first subcontractor may utilize the active projects requiring action box 415 to generate the task update for the contractor. The task update may be, for example, a message indicating that the first task is completed, an estimated date for when the first task will be completed and/or the like. Then, the contractor may inform the second subcontractor when the second task may be initiated. Alternatively, the system 1 and/or the application 30 may transmit the task update from the first subcontractor directly to the second subcontractor. For example, the system 1 and/or the application 30 may be designed and/or may be programmed to enable the contractor to direct the system 1 and/or the application 30 to transmit the task update from the user who has completed the task to the user that may have a subsequent task in the construction project.

The system 1, the server 20, the database 21 and/or the application 30 may be designed and/or may be programmed to display an active bid packages box 405. The active bid packages box 405 may display the construction projects posted by the user that have not initiated and/or the construction projects bid upon by the user that have not initiated. The user may select one or more of the construction projects displayed to view the project information associated with the selected construction project. The system 1 and/or the application 30 may remove one or more of the construction projects from the active bid packages box 405 if the construction project posted by the user is initiated.

The system 1, the server 20, the database 21 and/or the application 30 may be designed and/or may be programmed to display a project opportunities not viewed box 420. The project opportunities not viewed box 420 may display the search results obtained in the project searching/bidding step that have not been viewed and/or the search results obtained using the project searching/bidding screen 201 that have not been viewed. The project opportunities not viewed box 420 may display the project information associated with each of the construction projects displayed. The user may select one or more of the construction projects displayed in the project opportunities not viewed box 420 to view the project information associated with the selected construction project.

If the user selects and/or views one or more of the construction projects displayed in the project opportunities not viewed box 420, the system 1 and/or the application 30 may remove the construction project from the project opportunities not viewed box 420. The system 1 and/or the application 30 may display the selected and/or viewed construction project in the active project opportunities box 410 if the user selects and/or views one or more of the construction projects displayed in the project opportunities not viewed box 420. If the bid deadline passes for one of the construction projects displayed in the project opportunities not viewed box 420, the system 1 and/or the application 30 may be programmed and/or may be designed to remove the construction project associated with the bid deadline that has passed from the project opportunities not viewed box 420.

The system 1, the server 20, the database 21 and/or the application 30 may be programmed and/or may be designed to display a newly posted construction project on the account manager screen 401. For example, the system 1 and/or the application 30 may display the newly posted construction project in the active project opportunities box 410 and/or the project opportunities not viewed box 420. The system 1, the server 20, the database 21 and/or the application 30 may be programmed and/or may be designed to enable the user to provide project update criteria, such as, for example, a zip code, a distance from the zip code, a city, a state, a building type, a project value, a trade category and/or the like. For example, the user may input the project update criteria when the user registers for use of the system 1 and/or the application 30 and/or when the user obtains the username and/or password. The system 1 and/or the application 30 may query the user for the project update criteria if the user registers as a bidder. Alternatively, all users that register may be queried for project update criteria.

The user may utilize the system 1 and/or the application 30 to change the project update criteria. For example, the user may establish the project update criteria when registering for the system 1 and/or the application 30, and/or the user may later change the project update criteria. For example, the user may establish the update criteria to have a desired project value of $0.00 to $500,000.00, and/or the user may later change the project update criteria to have a desired project value of $500,000.00 to $1,000,000.00.

The system 1, the server 20, the database 21 and/or the application 30 may be programmed and/or may be designed to compare the project information for a newly posted construction project to the project update criteria. If the project information for the newly posted construction project matches and/or corresponds to the project update criteria established by the user, the system 1 and/or the application 30 may display the newly posted construction project on the account manager screen 401. For example, the system 1 and/or the application 30 may display the newly posted construction project in the active project opportunities box 410 and/or the project opportunities not viewed box 420. The system 1 and/or the application 30 may transmit an alert to the user that indicates that the newly posted construction project satisfies the project update criteria. For example, the alert may be an email, a text message, a message in the account manager of another user and/or the like. The present invention is not limited to a specific embodiment of the project update criteria or the alert.

The system 1, the server 20, the database 21 and/or the application 30 may be programmed and/or may be designed to display a bid package history box 425. The bid package history box 425 may display the construction projects posted by the user that have completed and/or the construction projects bid upon by the user that have completed. The user may select one or more of the construction projects displayed to view the project information associated with the selected construction project.

The system 1, the server 20, the database 21 and/or the application 30 may be programmed and/or may be designed to display a request information box 430 and/or a request information function 431. If the user selects the request information function 431, the application 30, the system 1, the server 20 and/or the database 21 may enable the user to enter a request for information. The system 1 and/or the application 30 may transmit the request for information to the user that posted the construction project as an email, a text message, a message in the account manager of another user and/or the like. The request information box 430 may display responses to previously sent requests for information. The system 1 and/or the application 30 may be programmed and/or may be designed to display the responses to previously sent requests for information to other users in addition to the user who transmitted the request for information. For example, the system 1 and/or the application 30 may display the responses to previously sent requests for information to all users.

The system 1, the database 20, the server 21 and/or the application 30 may be designed and/or may be programmed to display icons on the account management screen 401. The icons may be, for example, an icon indicating no action required, an icon indicating action required, an icon indicating bid submitted, an icon indicating review pending, an icon indicating new message, an icon indicating withdrawn bid and/or the like. The icons may be displayed in the active bid packages box 405, the active project opportunities box 410, the active projects requiring action box 415, the project opportunities not viewed box 420, the bid package history box 425 and/or the request information box. The present invention is not limited to a specific embodiment of the icons.

For example, the icon indicating bid submitted may be displayed adjacent to one of the construction projects in the active bid packages box 405 to indicate that the bid was submitted for the construction project. As a further example, the icon indicating review pending may be displayed adjacent to one of the construction projects in the active project opportunities box 410 to indicate that the construction project requires review and/or bidding. As another example, the icon indicating no action required may be displayed adjacent to a task in the active projects requiring action box 415 to indicate that the task does not currently require initiation and/or completion. As yet another example, the icon indicating action required may be displayed adjacent to a task in the active projects requiring action box 415 to indicate that the task currently requires initiation and/or completion.

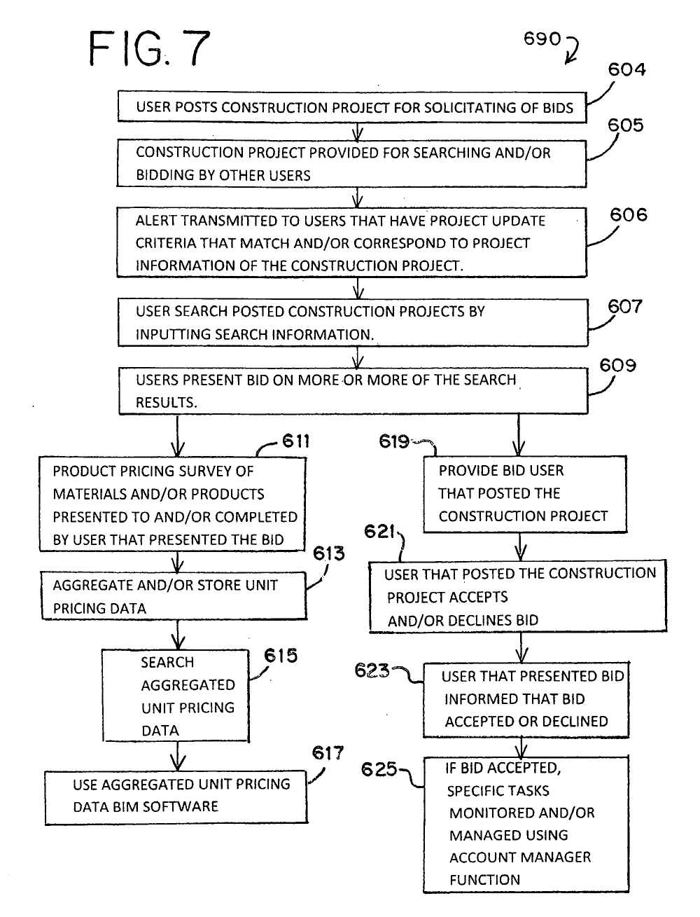

FIG. 7 generally illustrates a flowchart of a method 690 for managing construction project bids and/or unit pricing data in an embodiment of the present invention. A user may post a construction project for solicitation of bids as generally shown at step 604. For example, the user may input the project information for the construction project. The construction project may be provided for searching and/or bidding by other users as generally shown at step 605. An alert may be transmitted to users that have project update criteria that match and/or correspond to the project information of the construction project as generally shown at step 606. For example, the alert may be an email, a text message, a message in the account manager of another user and/or the like.

The other users may search posted construction projects by inputting search information as generally shown at step 607. The other users may present a bid on one or more of the search results as generally shown at step 609. The other users may present a bid on a construction project at a time when the search results are provided and/or at a subsequent time, such as, for example, using the account manager function. The other users may present a bid on a construction project without using the searching/bidding step, such as, for example, if the construction project is displayed in the account manager function because of the project update criteria.

The product-pricing survey of specific materials and/or products may be presented to and/or may be completed by the user that presented the bid as generally shown at step 611. The unit pricing data input in response to the product-pricing survey may be aggregated and/or may be stored as generally shown at step 613. The aggregated unit pricing data may be searched as generally shown at step 615. The search parameters for searching the aggregated unit pricing data may be, for example, a trade category, a sub-category, a material, a service, a zip code, a city, a state, a time period and/or the like. The aggregated unit pricing data may be used in the BIM software to calculate, to generate and/or adjust the cost estimate for the structure being built and/or designed as generally shown at step 617.

The bid may be provided to the user that posted the construction project as generally shown at step 619. The user that posted the construction project may accept and/or may decline the bid as generally shown at step 621. The user that presented the bid may be informed that the bid was accepted or declined as generally shown at step 623. If the bid is accepted, the specific tasks associated with the construction project may be monitored and/or may be managed using the account manager function as generally shown at step 625. For example, the task updates may be utilized to indicate initiation of the specific task, completion of the specific task, estimated date of initiation of the specific task, estimated completion date of the specific task, a delay in the specific task and/or the like.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A method for managing construction project bids for a plurality of construction projects for a first user, a second user, a third user and a fourth user wherein the first user, the second user, the third user and the fourth user are different users, the method comprising the steps of:
providing an application via a computer network wherein the computer network is connected to a database and further wherein the application communicates with the database via the computer network wherein the database stores project information associated with each of the plurality of construction projects and further wherein the application is accessed by a terminal connected to the computer network wherein the terminal is located remotely relative to the database wherein the first user posts a first construction project of the plurality of construction projects in the database and further wherein the database is provided by the second user;
inputting a bid for the first construction project wherein the third user inputs the bid using the application;
transmitting the bid to the first user;
presenting the third user with a survey that requests unit pricing information associated with the bid wherein the unit pricing information corresponds to costs associated with the bid and further wherein the application presents the survey;
inputting the unit pricing information wherein the third user inputs the unit pricing information using the application;
storing the unit pricing information in the database;
inputting a parameter using the application;
comparing the unit pricing information to the parameter; and
displaying the unit pricing information that corresponds to the parameter wherein the application displays the unit pricing information that corresponds to the parameter.

2. The method of claim 1 further comprising the step of:
inputting search criteria that is compared to the project information wherein the application displays a matching construction project from the plurality of construction projects based on comparison of the search criteria to the project information.

3. The method of claim 1 further comprising the step of:
transmitting a message to the third user that indicates acceptance of the bid by the first user.

4. The method of claim 1 further comprising:
generating a ranking for the third user wherein the ranking is based on feedback information input by the first user.

5. The method of claim 1 further comprising the step of:
transmitting the unit pricing information to building modeling software that uses the unit pricing information to calculate a cost estimate for a structure associated with the first construction project.

6. The method of claim 1 further comprising the step of:
displaying the project information for the first construction project and the project information for a second construction project of the plurality of projects.

7. The method of claim 1 further comprising the step of:
sending an update message to the first user that indicates a status of work associated with the first user wherein the update message is based on input by the first user and further wherein the status of the work indicates completion of the work.

8. The method of claim 1 further comprising the step of:
transmitting a discount offer to the first user wherein the discount offer provides a reduced cost for a purchase related to the construction project wherein the second user receives compensation if the first user uses the discount offer for the purchase.

9. The method of claim 1 further comprising the step of:
transmitting a message to the third user that indicates availability of a newly posted construction project from the database wherein the newly posted construction project was not available when the third user input the bid.

10. The method of claim 1 further comprising the step of:
indicating a number of the plurality of construction projects that are located in a first geographic area and a number of the plurality of construction projects that are located in a second geographic area wherein the first geographic area and the second geographic area are different geographic areas.

11. The method of claim 1 further comprising the step of:
obtaining contact information for users of the application wherein the application generates informational cards for the users of the application using the contact information and further wherein the application displays the informational cards.

12. The method of claim 1 further comprising the step of:
inputting a trade category that indicates a type of work provided by the third user wherein the survey is based on the trade category.

13. A method for managing construction project bids for a first user and a second user that are different users, the method comprising the steps of:
providing an application via a computer network wherein the computer network is connected to a database that communicates with the application via the network and further wherein the application is accessed by a terminal located remotely relative to the database via the computer network;
accepting user input for construction projects wherein the user input provides project information associated with the construction projects wherein the application accepts the user input and further wherein the database stores the project information wherein the project information indicates a plurality of types of work required for a corresponding construction project of the construction projects;
receiving a parameter that indicates a type of work performed by the first user wherein the application receives the parameter from the first user;
displaying a matching project from the construction projects wherein the matching project is selected based on comparison of the plurality of types of work required to the type of work provided by the first user and further wherein the application displays the matching project;
receiving a bid from the first user wherein the application receives the bid; and
obtaining unit pricing data associated with the bid wherein the unit pricing information corresponds to expenses associated with the bid and further wherein the unit pricing data is stored by the database wherein the unit pricing data corresponds to the type of work provided by the user.

14. The method of claim 13 further comprising the step of:
presenting a survey that obtains the unit pricing data wherein the application selects the survey based on the type of work provided by the first user.

15. The method of claim 13 further comprising the step of:
displaying the unit pricing data that is associated with a geographic area selected by the second user.

16. The method of claim 13 further comprising the step of:
transmitting a message to the first user wherein the message indicates that one or more of the plurality of types of work required for a new construction project corresponds to the type of work provided by the first user.

17. The method of claim 13 further comprising the step of:
displaying an account management webpage to the second user wherein the account management webpage indicates that the bid was transmitted.

18. A system for managing construction project bids, the system comprising:
a database connected to a network wherein the database stores project information associated with a plurality of construction projects;
an application associated with the database wherein the application is accessed by a computer connected to the network and further wherein the application accepts a bid for a first construction project of the plurality of construction projects;
a survey presented by the application wherein the survey obtains unit pricing data that corresponds to costs associated with the bid and further wherein the database stores the unit pricing data wherein the application accepts a parameter and further wherein the application displays the unit pricing data that corresponds to the parameter.

19. The system of claim 18 further comprising:
an account manager provided by the application wherein the account manager indicates entry of the bid.

20. The system of claim 18 further comprising:
user input that indicates a type of work provided in association with the bid wherein the application accepts the user input and further wherein the survey is selected based on the type of work provided in association with the bid.
